(19) United States
(12) Patent Application Publication
(10) Pub. No.: US 2010/0062198 A1
(43) Pub. Date: Mar. 11, 2010

(54) METHOD FOR PRODUCING HOLLOW BODY, AND HOLLOW BODY

(75) Inventors: Yoshinori Ohmura, Hirakata-shi (JP); Akira Uotani, Sodegaura-shi (JP); Tomoo Hirota, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED, Tokyo (JP); Sumika Plastech Co., Ltd., Ichihara-shi (JP)

(21) Appl. No.: 12/554,655

(22) Filed: Sep. 4, 2009

(30) Foreign Application Priority Data
Sep. 8, 2008 (JP) 2008-229385

(51) Int. Cl. B32B 1/02; B29C 49/00; B29C 49/22

(52) U.S. Cl. 428/35.7; 264/545; 264/511

(57) ABSTRACT

A method for producing a hollow body produced by shaping at least two thermoplastic resin sheets, comprising: a supplying step including supplying the at least two thermoplastic resin sheets to between a pair of mold members with the thermoplastic resin sheets superimposed one on another; a heating step including heating the thermoplastic resin sheets; a mold closing step including moving the mold members relatively toward each other to press the heated thermoplastic resin sheets together between the flanges of the mold members, thereby joining the sheets at a part of each of the sheets, the part being pressed with the flanges of the mold members; and a shaping step including sucking air out through the molding surfaces and simultaneously blowing air into the space(s) formed between the thermoplastic resin sheets, thereby making thermoplastic resin sheets facing the molding surfaces conform with the molding surfaces to shape the sheets into predetermined shapes, wherein the thermoplastic resin sheets are foamed sheets.

### BACKGROUND OF THE INVENTION

1. Field of the Invention

The present invention relates to a method for producing a hollow body obtained by shaping at least two thermoplastic resin sheets, and to a hollow body obtainable by this production method.

2. Background Art

As a conventionally used method for producing a hollow body, molding methods generally using a parison have been disclosed. For example, as disclosed in JP 2001-105482 A, a production method has been investigated wherein two sheets are superimposed, and then the two superimposed sheets are vacuum formed or pressure formed in the same direction while being heated at a predetermined temperature and kept in firm contact with each other, and then the peripheral portions of the two sheets are welded by predetermined means during, before or after the vacuum forming or pressure forming.

### Problems to be Solved by the Invention

However, in the practice of the production method disclosed in JP 2001-105482 A, great sagging (sagging may be referred to also as “drawdown”) of the sheets is developed under heating, so that the vacuum formability may become insufficient. In order to prevent sheets from sagging, molding conditions have sometimes been limited depending upon the type of the sheet to be used.

In view of the above problems, an object of the present invention is to provide a method for producing a hollow body by using thermoplastic resin sheets utilizing a vacuum forming technique, wherein the occurrence of sagging of the sheets can be prevented and, as a result, the vacuum fanning workability can be improved.

### Means to Solve the Problems

In one aspect, the present invention provides:

a method for producing a hollow body composed of at least two thermoplastic resin sheets, the method being performed by using a mold having a pair of mold members which can be moved relatively toward and away from each other along a fixed direction, each mold member having a molding surface, through which air can be sucked out, and a flange that surrounds the molding surface, and the method comprising:

a supplying step of supplying the at least two thermoplastic resin sheets to between a pair of mold members while superimposing the sheets one on another,

a heating step of heating the respective thermoplastic resin sheets,

a mold closing step of closing the mold members to closely sticking and joining at least a part of each of the heated thermoplastic resin sheets, which faces the molding surface flanges of the mold members, and

a shaping step of making the respective thermoplastic resin sheets conform with the molding surfaces to shape the sheets into predetermined shapes by sucking the air existing between the mold members through the molding surfaces of the mold members and simultaneously blowing air into the space(s) formed between the respective thermoplastic resin sheets,

wherein the thermoplastic resin sheets are foamed sheets, and

a hollow body obtainable by this method.

The “hollow body” as referred to in the present invention is a molded article that has, in at least a part of the article, a cavity defined by two thermoplastic resin sheets adjacent to each other.

When a hollow body is produced by using two or more thermoplastic resin sheets by the method of the present invention, the occurrence of sagging of the sheets is successfully prevented and it is possible to produce a hollow body having good appearance at an improved vacuum forming workability.

### BRIEF DESCRIPTION OF THE DRAWINGS

FIG. 1 is a diagram that illustrates one embodiment of the method according to the present invention.

FIG. 2 is a diagram that illustrates another embodiment of the method according to the present invention.

FIG. 3 is a diagram that illustrates a scene of a mold closing step in one embodiment of the method according to the present invention.

FIG. 4 is a diagram that illustrates a scene of a mold closing step in another embodiment of the method according to the present invention.

### DESCRIPTION OF THE PREFERRED EMBODIMENTS OF THE INVENTION

The present invention is described below with reference to the drawings, but the invention is not limited to the examples depicted.

### [Mold]

In the present invention; is used a mold having a pair of mold members each having a molding surface, through which air can be sucked, and a flange that surrounds the molding surface. The mold is configured so that the mold members can be moved relatively toward and away from each other along a fixed direction. An operation of moving the mold members relatively toward each other along the fixed direction is called “mold closing” or “mold closure.” On the other hand, an operation of moving the mold members relatively away from each other along the fixed direction is called “mold opening.” Examples of the mold to be used include a mold having a male mold member and a female mold member, and a mold having two female molds.

Examples of the mold member having a molding surface through which air can be sucked include a mold member having a molding surface at least part of which is formed of a sintered alloy, and a mold member having a molding surface in at least part of which two or more holes are provided. The number, the location and the diameter of the holes that the mold members are provided with are not particularly limited and may be determined so that thermoplastic resin sheets that have been supplied to between the mold members can be shaped into the shapes of the molding surfaces of the mold members by sucking air through the holes.

While the mold members have no particular limitations on their material, they are normally made of a metal from the viewpoint of dimensional stability, durability, thermal conductivity and so on. In view of cost and light weight, the mold members are preferably made of aluminum.

Both the mold members are preferably configured so that the temperature thereof can be controlled with a heater, a heat medium, or the like. From the viewpoint of increasing the slipping property between a molding surface and a thermoplastic resin sheet and the viewpoint of preventing a thermoplastic resin sheet from being cooled before the completion of shaping, it is preferable to hold the molding surfaces of the mold members at 30° C. to 80° C., and more preferably at 50° C. to 60° C.

It is desirable to use a mold having two mold members, one or both of which have an airtightness holding part. When such a mold is used, it is easy to maintain the degree of vacuum within a cavity defined by the molding surfaces when vacuum suction is performed.

One example of a mold having an airtightness holding part is a mold having a pair of mold members at least one of which has, within or adjacent to its flange, a movable member that can be moved toward and away from the opposing mold member. In the case of using such a mold, it is desirable that the mold have such a structure that the movable member can be retracted so that the front end part of the movable member will form substantially no step at the boundary between the movable member and the surface of the flange that surrounds or adjoins the movable member at the time of the completion of mold closure. If the mold is configured so that the movable member can move toward the opposing mold member as the mold member are moved away from each other, it is easy to maintain the degree of vacuum within a cavity formed between the molding surfaces easily during the mold opening step described later.

Another example of the mold having an airtightness holding part is a mold having two mold members at least one of which has a buffer material on its flange. The thermoplastic resin sheets to be used for the present invention are foamed sheets, which usually have minute irregularities on their surfaces. When using a mold having a mold member with a buffer material, it is easy to maintain the degree of vacuum within the cavity defined by the molding surfaces when vacuum suction is performed because the buffer material sticks with a foamed sheet surface with minute irregularities through mold closure. Examples of the buffer material include rubbers and foamed materials.

It is also permissible to use a mold having such a configuration that one mold member is covered with an airtightness holding part mounted to the periphery of the other mold member when the mold is closed.

On the molding surface and/or the flange of each mold member may be provided with a member for fixing a foamed sheet. For example, an adhesive material may be provided partly or throughout on the molding surface and/or the flange, or alternatively a pin, a hook, a clip, a slit, and so on may be provided. The use of such a mold member makes it easy to shape a foamed sheet into the shape of the molding surface.

It is desirable to use such a mold that the height of the cavity formed when the mold is closed is from about 1.5 times to about 10 times the thickness of the foamed sheets superimposed. The height of a cavity as referred to herein is the distance between the molding surfaces of the mold members, the distance being measured along the direction along which the mold is closed and opened. The cavity does not need to have a fixed height and may be any cavity that corresponds to the shape of the intended hollow body. If the height of the cavity is extremely low, cells of the foamed sheets may be broken at the time of mold closure. If it is extremely high, as will be described later, it becomes difficult to bring the foamed sheets into contact with the molding surfaces to shape the sheets even if vacuum suction is performed, and cells is prone to break even if the molding surfaces are brought into contact with the foamed sheets.

The method according to the present invention has a supplying step, a heating step, a mold closing step, and a shaping step.

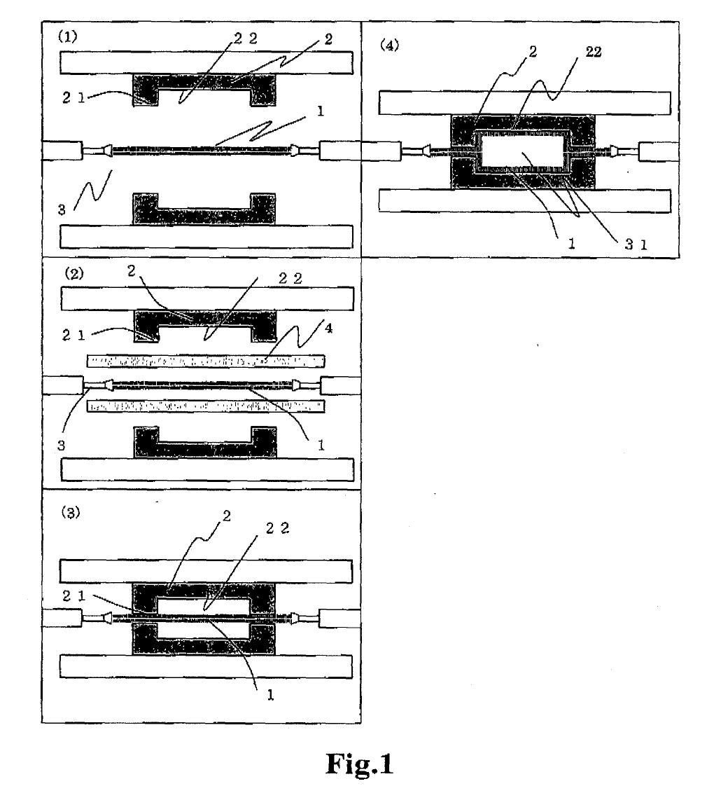

The supplying step refers to a step comprising supplying at least two thermoplastic resin sheets to between the mold members with the thermoplastic resin sheets superimposed one on another. FIG. 1-(1) is a diagram that illustrates a state that two thermoplastic resin sheets 1, which may hereinafter be referred to only as sheets, are supplied to between mold members 2. It is preferable to clamp both ends of the sheets 1 with a clamping frame 3 while the sheets are superimposed one on another. Clamping both ends of the sheets 1 makes the sheets 1 resistant to sagging in the following heating step.

In this exemplary embodiment, female aluminum mold members each provided with holes in the molding surfaces were used as the mold members 2.

FIG. 1-(2) is a diagram that illustrates a scene of a heating step. The heating step is a step comprising heating the sheets 1, which have been supplied in the supplying step, with a heating device 4. Examples of the heating device include a far-infrared heater, a near-infrared heater, and a contact type hot plate. Among these, the use of a far-infrared heater is preferable because it can efficiently heat the sheets in a short time. As to the heating of the sheet 1, if the resin that forms the sheet 1 is a crystalline resin, it is desirable to heat the sheet 1 so that the surface temperature of the sheet 1 will become a temperature near the melting point of the crystalline resin. It is more desirable to heat the sheet 1 so that the temperature of the sheet will become near the melting point uniformly with respect to the thickness direction of the sheet 1. If the resin that forms the sheet 1 is a noncrystalline resin, it is desirable to heat the sheet 1 so that the surface temperature will become near the glass transition temperature.

FIG. 1-(3) is a diagram that illustrates a scene of a mold closing step. The mold closing step is a step comprising moving the mold members 2 relatively toward each other to press the heated sheets 1 together between the flanges 21 of the mold members 2, thereby joining the sheets at a part of each of the sheets, the part being pressed with the flanges of the mold members. Usually, the sheets are joined by being welded to each other. The mold is closed until the clearance defined between the flanges 21 of the mold members 21 becomes equal to or smaller than the sum total of the thicknesses of the sheets 1. The closure of the mold may be carried out either by moving only one of the mold members toward the other mold member or by moving both the mold members toward one another. Moreover, it is also possible to unify the sheets 1 at a part other than the flanges 21 by appropriately designing the shape of the molding surfaces of the mold members.

FIG. 1-(4) is a diagram that illustrates a scene of a shaping step. The shaping step refers to a step comprising sucking air out through the molding surfaces 21 and simultaneously blowing air into the space(s) formed between the sheets 1, thereby making sheets facing the molding surfaces conform with the molding surfaces to shape the sheets into predetermined shapes. The air is sucked through the holes provided in the molding surfaces 22 by the action of a vacuum pump or the like.

The vacuum suction is started at a time after the clearance between the mold members at their flanges 21 becomes equal to or smaller than the sum total of the thicknesses of the two heated, softened sheets 1 or after the sheets have come to have a predetermined thicknesses. For example, in one possible embodiment, vacuum suction is started when the clearance between the mold members at their flanges 21 becomes equal to the sum total of the thicknesses of the sheets 1 and the mold members 2 are further closed to a predetermined thickness with the vacuum suction continued. In another possible embodiment, vacuum suction is started at the time when or after the clearance becomes a predetermined thickness. When vacuum suction is started after the clearance becomes a predetermined thickness, it is desirable to start the vacuum suction before the foamed sheets are cooled and within three seconds from the time when the clearance becomes the predetermined thickness.

As to the timing of starting vacuum suction, it is desirable to start vacuum suction at the same instant through both the mold members in order to obtain a molded article having a uniform internal structure. While vacuum suction may be started at a time lag as long as the sheets 1 are not cooled, the difference between the start times is preferably within three seconds.

While the degree of the vacuum suction is not particularly limited, the vacuum suction is preferably carried out so that the degree of vacuum of a gap between a molding surface 22 and a sheet 1 will become −0.05 to −0.1 MPa. The degree of vacuum is the pressure in the gap between the molding surface 22 and the sheet 1 relative to the atmospheric pressure. That is, “the degree of vacuum is −0.05 MPa” means that the pressures in the gap between the molding surface 22 and the sheet 1 is 0.95 MPa. Since the higher the degree of vacuum is, the more strongly a foamed sheet is pressed against a mold member, it becomes easier to shape the foamed sheet in conformity with the cavity shape. The degree of vacuum of a cavity is a value measured at the opening to the cavity of a hole through which vacuum suction is performed.

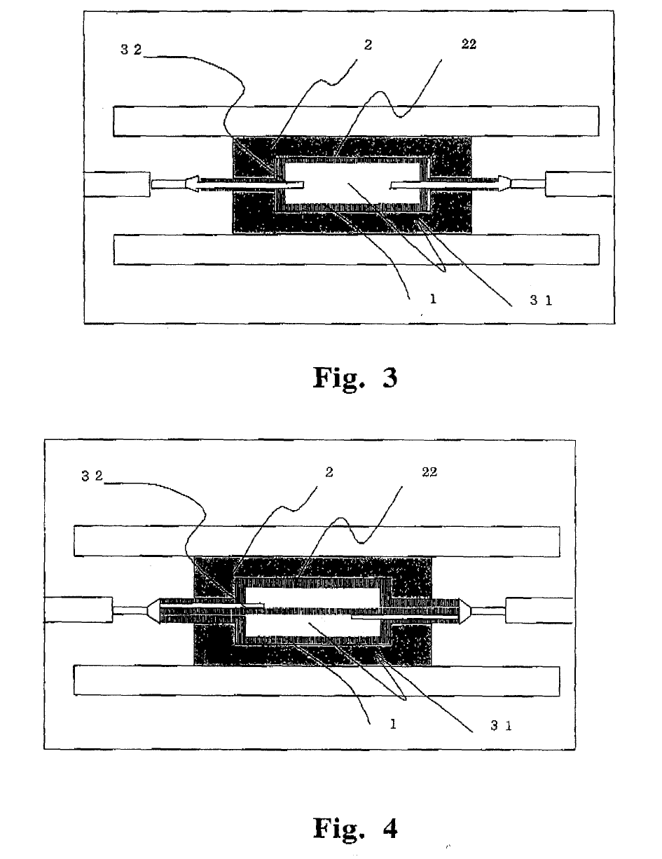

One example of the method for blowing air into a space 31 formed between the sheets 1 is a method including putting a tube 32 between one sheet 1 and another sheet 1 during the aforementioned supplying step and forcing or allowing air to enter to between the sheets (see FIG. 3). This allows the outside air to be introduced into the space 31 even if mold closure is performed. Therefore, a pressure difference is generated between the inside and the outside of the space 31 defined by the sheets 1 and, as a result, it becomes possible to make the sheets easier to be shaped in conformity with the molding surfaces 22.

It is also permissible to make a pressure difference easier to be generated by blowing air through the tube 32. At this time, the temperature of the air to be blown is preferably 60 to 200° C. from the viewpoint of improvement in shapability. The air can be blown by connecting one end of the tube 32 to a compressor or the like (not shown).

The method of the present invention may further have a pressure reducing step comprising reducing the pressure within the space 31 formed between the sheets 1 after the execution, preferably after the completion, of the above-mentioned shaping step. The provision of the pressure reducing step prevents the sheets 1 from becoming thinner and, as a result, it becomes possible to increase the thickness of the wall of the hollow body to be obtained. The reduction of pressure can be performed by connecting one end of the tube used in the shaping step to a pump. At this time, the degree of vacuum within the space(s) 31 is preferably 0.01 MPa to 0.1 MPa. The pressure reduction time is not particularly limited as long as the pressure can be reduced until the sheets 1 come to have a desired thickness. The pressure reduction is preferably performed within three seconds from the completion of the shaping step.

While a method for producing a hollow body by using two thermoplastic resin sheet, the method according to the present invention may be carried out also by using three thermoplastic resin sheets or by using four or more thermoplastic resin sheets. The number of the thermoplastic resin sheets to be used may be determined appropriately depending on the characteristics (e.g., light weight property, and shape) that the hollow article to be produced will be required to have in its intended application.

### (In the Case of Using Three Sheets)

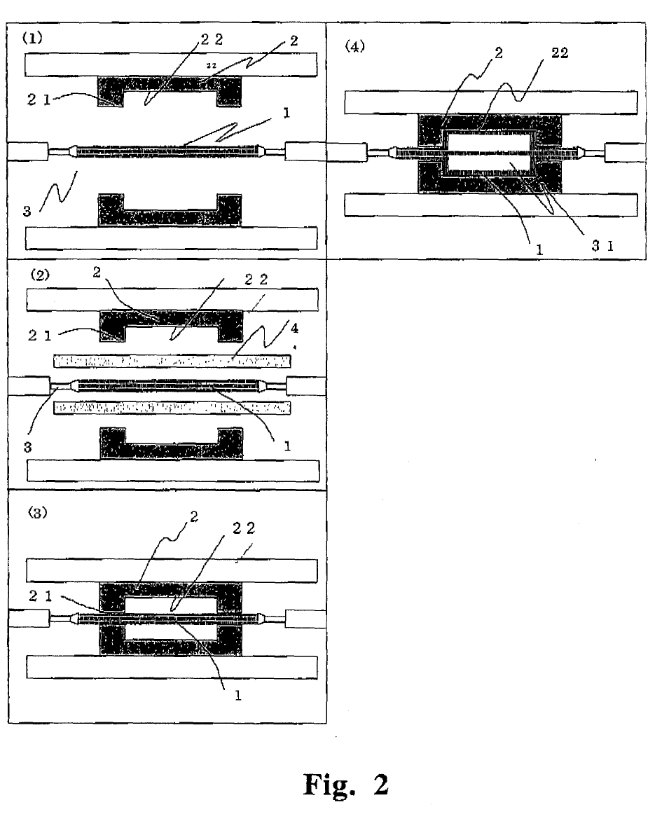

FIG. 2-(1) is a diagram that illustrates a state that three thermoplastic resin sheets 1 are supplied to between mold members 2 with the sheets superimposed one on another. When three sheets, namely two outer sheet and one intermediate sheet, are superimposed, the space defined between the outer sheets is divided into two sections by the intermediate sheet. As a result, it becomes possible to reduce or increase the pressure within one of the two sections selectively during the following shaping step. In another embodiment, it is possible to reduce or increase the pressure within one of the two sections first and, after a lapse of a prescribed period of time, reduce or increase the pressure within the other section. A combination of the use of three sheet and the execution of such operations provides the increase in the flexibility in the shape of hollow bodies to be produced.

FIG. 2-(2) is a diagram that illustrates a scene of a heating step. FIG. 2-(3) is a diagram that illustrates a scene of a mold closing step. FIG. 2-(4) is a diagram that illustrates a scene of a shaping step. FIG. 4 is a diagram that illustrates a state that tubes 32 for blowing therethrough air into the spaces 31 defined by the sheets 1 have been inserted to between the sheets,

### (In the Case of Using Four or More Sheets)

When four or more thermoplastic resin sheets, namely two outer sheets and two or more intermediate sheets, are superimposed, the space defined between the outer sheets is divided into three or more sections. As a result, it becomes possible to reduce or increase the pressure within one or more selected sections selectively or preferentially, resulting in the increase in the flexibility in the shape of hollow bodies to be produced.

### (In the Case of Using Acoustic Absorbing Material)

In a modified embodiment, a fibrous acoustic insulation sheet is disposed between thermoplastic resin sheet to be superimposed. One example of the fibrous acoustic insulation sheet is THINSULATE™ available from 3M. When a hollow body having such a fibrous acoustic insulation sheet located in a hollow portion has been produced, a hollow product with excellent acoustic performance can be obtained by forming a through hole in the wall of the hollow portion to connect the inside of the hollow portion with the atmosphere surrounding the product.

The method of the present invention may further have a step comprising blowing air again into the space(s) 31 after the execution, preferably after the completion, of the pressure reducing step. The additional blowing of air makes it possible to increase the pressure in the space(s) 31 after the pressure reducing step to normal pressure, so that it becomes possible to prevent a resulting hollow body from deforming. Air is preferably blown until the degree of vacuum within the space(s) 31 becomes 0 MPa to 0.01 MPa. Moreover, the blowing of air is preferably carried out immediately after the execution of the pressure reducing step. This allows a resulting hollow body to be cooled promptly.

### [Thermoplastic Resin Sheet]

In the method of the present invention for producing a hollow body are used thermoplastic resin sheets. The thermoplastic resin sheets are foamed sheets. The use of foamed sheets prevents the sheets from sagging, so that it becomes possible to improve vacuum forming workability.

Examples of the thermoplastic resin for forming the sheets include thermoplastic resins that are ordinarily used for compression molding, injection molding, extrusion fanning, and so on. Examples of such resins include general thermoplastic resins, such as polypropylene, polyethylene, acrylonitrile-styrene-butadiene block copolymers, polystyrene, polyamides, such as nylon, polyvinyl chloride, polycarbonate, acrylic resins, and styrene-butadiene block copolymers, thermoplastic elastomers, such as ethylene-propylene rubbers (e.g., EPM, EPDM), mixtures thereof, and polymer alloys made therefrom. These can be used singly or in combination.

The thermoplastic resin sheets to be used in the present invention are foamed sheets, which are each preferably a sheet having such a configuration that one or more foamed layers are disposed between two unfoamed layers, i.e., a first unfoamed layer and a second unfoamed layer. Considering the sagging that occurs during production steps and the shapability of sheets, it is desirable that both the unfoamed layers and the foamed layer each contain a propylene-based resin as a principal ingredient. The propylene-based resins used for the unfoamed layers each preferably have a melting point that is lower than that of the propylene-based resin used for each of the foamed layers. By using, for unfoamed layers, a resin having a lower melting point than that of the resin of the foamed layer, it becomes possible to lower the heating temperature in shaping and, as a result, it is possible to prevent the deterioration of shapability caused by drawdown and cell breakage. In particular, it is preferable to use, for unfoamed layers, a resin having a melting point that is 10 to 100° C. lower than the melting point of the resin used for the foamed layer.

The unfoamed layers may be made of a propylene-based resin added with a filler. The addition of a filler improves the heat resistance of the unfoamed layers and makes it possible to prevent the occurrence of drawdown. Examples of the filler to be used include inorganic fibers, such as glass fiber and carbon fiber, and inorganic particles, such as talc, clay, silica, and calcium carbonate.

The expansion ratio of each foamed layer is preferably 2 to 10, and more preferably 3 to 9, The adoption of such an expansion ratio makes it possible to prevent the occurrence of sagging of a sheet during the production of a hollow body and to reduce the breakage of cells in the foamed layers. When a foamed sheet having one or more foamed layers are disposed between a first unfoamed layer and a second unfoamed layer, the ratio of the sum total of the thicknesses of the unfoamed layer to the sum total of the thicknesses of the foamed layers (unfoamed layer/foamed layer) is preferably from 0.002 to 0.30, and more preferably from 0.010 to 0.12. Moreover, the thickness ratio of the first unfoamed layer to the second unfoamed layer (first unfoamed layer/second unfoamed layer) is preferably from 0.5 to 2, more preferably from 0.8 to 1.3, and even more preferably 1. The adoption of such a thickness ratio makes it possible to prevent the occurrence of sagging of a sheet during the production of a hollow body.

The total thickness of the foamed layer(s) is preferably 3 mm to 10 mm, and more preferably 3 mm to 9 mm. The total thickness of the unfoamed layers is preferably 20 μm to 600 μm, and more preferably 100 μm to 400 μm.

While the thermoplastic resin sheets in according with the present invention can be produced by conventional methods, such as extrusion foaming, in-mold bead foaming, and foaming using electron beam crosslinking or chemical crosslinking, it is desirable, from the viewpoint of productivity and recycling efficiency, to produce them by extrusion foaming. It is desirable that the sheet in which a foamed layer is disposed between at least two unfoamed layers be produced by the use of a multimanifold type T die.

As the foaming agent to be used for the production of sheets, a physical foaming agent or a chemical foaming agent which are used for ordinary expansion molding may be used singly, or two or more kinds of them may be used in combination.

Examples of physical foaming agents to be suitably used include carbon dioxide gas, nitrogen gas, air, propane, butane, pentane, hexane, dichloroethane, dichlorodifluoromethane, dichloromonofluorornethane, and trichloromonofluoromethane. Among these, nitrogen gas, carbon dioxide gas, or air is preferably used.

When using a physical foaming agent as a foaming agent, it is necessary to supply the physical foaming agent under pressure to a thermoplastic resin under melt-kneading within an extruder to prepare a resin composition and further melt-knead this. The amount of the physical foaming agent to be supplied under pressure is preferably 0.1 to 10 parts by weight per 100 parts by weight of the resin for forming a foamed layer.

When using a physical foaming agent as a foaming agent, it is desirable to add a cell nucleating agent. Examples of such a cell nucleating agent include talc, silica, diatomite, calcium carbonate, magnesium carbonate, barium sulfate, aluminum hydroxide, magnesium hydroxide, calcium hydroxide, calcium silicate, zeolite, mica, clay, wollastonite, hydrotalcite, magnesium oxide, zinc oxide, zinc stearate, calcium stearate, beads of polymer, such as PMMA, and synthetic aluminosilicate. The following chemical foaming agents can also be used as cell nucleating agents. The added amount of a cell nucleating agent is preferably 0.1 to 10 parts by weight per 100 parts by weight of the thermoplastic resin.

A chemical foaming agent may also be used as a foaming agent. Examples of the chemical foaming agent include such conventional compounds as sodium bicarbonate, mixtures of sodium bicarbonate and an organic acid, such as citric acid, sodium citrate and stearic acid, azodicarbonamide, isocyanate compounds, such as tolylene diisocyanate and 4,4′-diphenylmethane diisocyanate, azo or diazo compounds, such as azobisbutyronitrile, barium azodicarboxylate, diazoaminobenzene and trihydrazinotriazine, hydrazine derivatives, such as benzenesulfonyl hydrazide, p,p′-oxybis(benzenesulfonyl hydrazide) and toluenesulfonyl hydrazide, nitroso compounds, such as N,N′-dinitrosopentamethylenetetramine and N,N′-dimethyl-N,N′-dinitroso terephthalamide, semicarbazide compounds, such as p-toluenesulfonyl semicarbazide and 4,4′-oxybis(benzenesulfonyl semicarbazide), azide compounds, and triazole compounds. Among these, sodium bicarbonate, citric acid, or azodicarbonamide is preferably used.

When using a chemical foaming agent, the added amount thereof is preferably 0.1 to 20 parts by weight per 100 parts by weight of the thermoplastic resin. When using a chemical foaming agent as a foaming agent, a foaming aid, such as zinc oxide, zinc stearate, and urea, may be added in order to adjust the decomposition temperature and the decomposition rate of the foaming agent.

Hollow bodies according to the present invention are lighter than conventional hollow bodies obtained by using unfoamed sheets, and they are excellent in stiffness and compression strength. Therefore, they can be used for automotive components, building materials, and so on.

### Examples

The present invention is hereafter further explained on the basis of Examples, but the invention is not limited to the Examples.

### [Measurement of Physical Properties]

### (1) Expansion Ratio

The density, ρ(water), of a foamed sheet was determined using the immersion method disclosed in JIS K7112. Then, an expansion ratio, X (dimensionless), was calculated by the following [Formula 1] by using the density, ρ, of the resin forming the foamed sheet. In this Example, since a propylene-based resin was used as the resin, it was assumed that ρ=0.90 g/cm³.

X=ρ/ρ(water) [Formula 1]

ρ: density (g/cm³) of resin

ρ(water):density (g/cm³) of a foamed sheet

### (2) Flexural Modulus

A flexural modulus was measured using an Autograph (Model AGS-10kNG, manufactured by Shimadzu Corporation) in accordance with JIS K7203. As to the flexural modulus, a specimen was supported horizontally at two points, a load was applied at the center between the fulcrums, and the correlation between the load and flexure was examined. The loading rate was 50 mm/min. From the inclination of a load-flexure curve at its minimum load straight portion, a flexural modulus (MPa) was calculated by the following [Formula 2]:

E=1³/4bh³xp/y [Formula 2]

wherein E is the flexural modulus (MPa), 1 is the span distance (100 mm), b is the specimen width (50 mm), h is the specimen thickness, and p/y is the inclination (N/cm) of the load-flexure curve at its minimum load straight portion.

### (3) Calculation of Drawdown

Subsequently, the foamed sheet was clipped at its both ends with clamps, and the amount of its drawdown (epsilon) generated when being heated with a heater was calculated. In the calculation was used a formula of flexure [Formula 3] that is used in the field of strength of materials when a foamed sheet fixed at its both ends receives a uniformly distributed load (own weight). In this Example, b=1 m and 1=1.2 m were substituted into the [Formula 3].

Epsilon=p1⁴/32Ebh³ [Formula 3]

wherein p is the load (N/m) per unit length, 1 is the span distance, E is the flexural modulus (MPa), b is the width (m) of the foamed sheet, and h is the thickness (m) of the foamed sheet.

### [1] Preparation of a Foamed Sheet

### Example 1

A foamed sheet composed of only a foamed layer was produced. As the resin for the foamed sheet was used a mixture of 100 parts by weight of a propylene-based resin composition containing a propylene-ethylene copolymer (available under the name of NOBLENE AW161 from Sumitomo Chemical Co., Ltd.) as a principal ingredient and 0.3 parts by mass of a cell nucleating agent masterbatch. The cell nucleating agent masterbatch was a composition composed of about 70% by weight of an ethylene-based base resin as a matrix and about 30% by weight of azodicarbonamide having an average particle diameter of 4.48 μm. These materials were charged into a hopper of an extruder for the foamed layer by using a metering feeder, and were melt-kneaded in the extruder. As the extruder for the foamed layer was used a 104 mmφ co-rotating twin screw extruder (L/D=32, where L is the effective screw length, and D is the screw diameter) equipped with a gear pump at its front end.

At a position where melting of the materials had been advanced, liquefied carbon dioxide gas was supplied in an amount of 0.35 parts by mass per 100 parts by mass of the polypropylene block copolymer, under high pressure by using a diaphragm type metering pump. After thoroughly melt-kneading the molten resin and the carbon dioxide gas together, the resultant material was fed into a multimanifold type multilayer T die by using the gear pump, and then a foamed sheet was extruded at a discharge rate of 200 kg/h.

The foamed sheet extruded from the outlet of the die was cooled and shaped with a plurality of 210φ rolls that were located just after the die and were cooled to about 60° C., hauled off with a hauling-off machine equipped with nip rolls, and then cut with a cutter into a predetermined size. In the foamed sheet obtained by this method, the foamed layer had an expansion ratio of 3, a thickness of 3 mm, and a weight of 900 g/m² as shown in Table 1. A specimen for a bending test was cut out from this foamed sheet and then a bending test was performed. As a result, the flexural modulus at normal temperature (23° C.) was 505 MPa and a flexural modulus at a high temperature (110° C.) was 127 MPa. The amounts of drawdown of the foamed sheet at normal temperature (23° C.) and a high temperature (110° C.) were calculated by the procedure described above. The results are shown in Table 2.

### Example 2

A multilayer foamed sheet comprising a foamed layer and two unfoamed layers, one on each side of the foamed layer, was produced. As the extruder for the foamed layer was used a 104 mmφ co-rotating twin screw extruder (L/D=32, where L is the effective screw length, and D is the screw diameter) equipped with a gear pump at its front end, and as the extruder for the unfoamed layers was used a 75 mmφ single screw extruder (L/D=32).

As the resin for the foamed layer was used the same resin as that of Example 1. As the resin for the unfoamed layers was used a resin composition prepared by adding 30 parts by mass of talc to 100 parts by mass of a polypropylene block copolymer. The resin composition for the foamed layer was charged into a hopper of the extruder for the foamed layer and the resin composition for the unfoamed layers was charged into a hopper of the extruder for the unfoamed layers using a metering feeder. Then the resin composition for the foamed layer and the resin composition for the unfoamed layers were supplied to a multimanifold type multilayer T die and were lamination-extruded at a discharge rate of 200 kg/h for the resin composition for the foamed layer and at a discharge rate of 62 kg/h for the resin composition for the unfoamed layers.

A multilayer foamed sheet extruded from the outlet of the die was cooled and shaped with a plurality of 210φ rolls that were located just after the die and were cooled to about 60° C., hauled off with a hauling-off machine equipped with nip rolls, and then ° cut with a cutter into a predetermined size.

In the resulting multilayer foamed sheet, the foamed layer had an expansion ratio of 3 and a thickness of 3 mm, and the unfoamed layers each had a thickness of 130 μm as shown in Table 1. The weight was 1194 g/m². A specimen for a bending test was cut out from this foamed sheet and then a bending test was performed. As a result, the flexural modulus at normal temperature (23° C.) was 1010 MPa and a flexural modulus at a high temperature (110° C.) was 274 MPa. Moreover, the amounts of drawdown at normal temperature (23° C.) and at a high temperature (110° C.) were calculated by the same method as Example 1. The results are shown in Table 2.

### Comparative Example 1

An unformed sheet having a thickness of 2 mm and a weight of 1800 g/m² was produced by using the same resin as that of Example 1. This unfoamed sheet is one obtained by performing injection molding at a molding temperature of 220° C., a mold cooling temperature of 50° C., an injection time of 15 seconds, and a cooling time of 30 seconds by using an injection molding machine IS150E-V manufactured by Toshiba Machine Co., Ltd.

A specimen was cut out from the unformed sheet and then a bending test was performed. As a result, the flexural modulus at normal temperature (23° C.) was 1500 MPa and a flexural modulus at a high temperature (110° C.) was 375 MPa. Moreover, the amounts of drawdown were calculated by the same method as Example 1. The results are shown in the following table.

TABLE 1

| | | Total | | Flexural modulus | |
|---|---|---|---|---|---|
| | Thermoplastic | thickness | Weight | (MPa) | |
| | resin sheet | (mm) | (kg/m²) | 23° C. | 110° C. |
| Example 1 | Foamed sheet | 3.0 | 900 | 505 | 127 |
| Example 2 | Multilayer | 3.3 | 1194 | 1010 | 274 |
| | foamed sheet | | | | |
| Comparative | Unfoamed sheet | 2.0 | 1800 | 1500 | 375 |
| Example 1 | | | | | |

TABLE 2

| | |
|---|---|
| | Amount of drawdown |
| Thermoplastic resin | (cm) |

| | sheet | 23° C. | 110° C. |
|---|---|---|---|
| Example 1 | Foamed sheet | 4 | 17 |
| Example 2 | Multilayer foamed | 2 | 9 |
| | sheet | | |
| Comparative | Unfoamed sheet | 10 | 38 |
| Example 1 | | | |

### [2] Production of Hollow Body

### Example 3

A mold having a pair of mold members made of aluminum, each of which was a female mold having a molding surface and a flange, were provided. Two sheets prepared in Example 1 were superimposed and clamped with clamping frames at both ends of the sheets. The superimposed, clamped sheets were supplied to between the mold members kept at 30° C. Then, a tube was inserted to between the sheets, so that a state that air could be blown into or sucked from between the sheets was established. The sheets supplied were heated to about the melting point of the sheets with a far-infrared heater. After the heating, the mold members were moved toward each other, so that the heated sheets were pressed together between the flanges of the mold members and, as a result, were joined at the parts of the sheets pressed with the flanges. Then, while the air was sucked through the mold surfaces, air was blown through the tube into the space defined between the sheets. Thus, the sheets were made conform with the molding surfaces, thereby being fabricated into a hollow body having a prescribed shape. The resulting hollow body was cooled between the mold members, and then the mold members were opened and the hollow body was taken out. The hollow body had good appearance with no defects, such as wrinkles, caused by drawdown of the sheets.

### Example 4

A hollow body was produced in the same manner as Example 3 except for using the sheets produced in Example 2. The hollow body had good appearance without defects, such as wrinkles, caused by drawdown of the sheets.

1. A method for producing a hollow body composed of at least two
thermoplastic resin sheets, the method being performed by using a mold having a pair of mold members which can be moved relatively toward and away from each other along a fixed direction, each mold member having a molding surface, through which air can be sucked out, and a flange that surrounds the molding surface, and the method comprising:
a supplying step comprising supplying the thermoplastic resin sheets to between the mold members with the thermoplastic resin sheets superimposed one on another,
a heating step comprising heating the thermoplastic resin sheets,
a mold closing step comprising moving the mold members relatively toward each other to press the heated thermoplastic resin sheets together between the flanges of the mold members, thereby joining the sheets at a part of each of the sheets, the part being pressed with the flanges of the mold members, and
a shaping step comprising sucking air out through the molding surfaces and simultaneously blowing air into the space(s) formed between the thermoplastic resin sheets, thereby making thermoplastic resin sheets facing the molding surfaces conform with the molding surfaces to shape the sheets into predetermined shapes,
wherein the thermoplastic resin sheets are foamed sheets.

2. The method according to claim 1, wherein the temperature of the air blown into the space(s) formed between the thermoplastic resin sheets during the shaping step is 60° C. to 200° C.

3. The method according to claim 1, further comprising a pressure reducing step of reducing the pressure within the space(s) formed between the thermoplastic resin sheets after the execution of the shaping step.

4. The method according to claim 3, further comprising a step of blowing air into the space(s) formed between the thermoplastic resin sheets after the execution of the pressure reducing step.

5. The method according to claim 1, wherein each of the foamed sheets comprises two unfoamed layers and one or more foamed layers that are interposed between the unfoamed layers.

6. The method according to claim 5, wherein each of the foamed layers has an expansion ratio of from 3 to 10, and the ratio of the sum total of the thicknesses of the unfoamed layers to the sum total of the thicknesses of the foamed layers (unformed layers/foamed layers) is 0.002 to 0.30.

7. The method according to claim 5, wherein the foamed layers and the unfoamed layers in each of the thermoplastic resin sheets are each independently made of a propylene-based resin composition containing a propylene-based resin as a principal ingredient, and wherein in each of the thermoplastic resin sheets, the propylene-based resin of each of the unfoamed layers is lower in melting point than the propylene-based resin of any of the foamed layers.

8. A hollow body obtained by the method according to claim 1.
